(19) United States
(12) Patent Application Publication
(10) Pub. No.: US 2016/0132600 A1
(43) Pub. Date: May 12, 2016

(54) Methods and Systems for Performing Content Recognition for a Surge of Incoming Recognition Queries

(71) Applicant: Shazam Investments Limited, London (GB)

(72) Inventors: Ira Joseph Woodhead, San Francisco, CA (US); Avery Li-Chun Wang, Palo Alto, CA (US); Charles Robert Henrich, London (GB); Saulius Grusnys, London (GB); Scott Matthew Loyd, Brentwood, CA (US)

(21) Appl. No.: 14/535,666

(22) Filed: Nov. 7, 2014

(51) Int. Cl. G06F 17/30

(52) U.S. Cl. CPC G06F 17/30867; G06F 17/30516

(57) ABSTRACT

Methods and systems for performing content recognition for a surge of incoming recognition queries are provided. Within examples, methods comprise receiving, by one or more computing devices, a stream of incoming content recognition queries, and a given content recognition query includes a sample of media content and a request to identify the sample of media content. Methods also comprise filtering, by the one or more computing devices, a plurality of content recognition queries from the stream of incoming content recognition queries belonging to a surge event, and the surge event is associated with content recognition queries received within a time window and including common samples of media content.

### BACKGROUND

Media content identification from samples of media sources within various environments is a valuable and interesting information service. User-initiated or passively-initiated content identification of media samples has presented opportunities for users to connect to target content of interest including music and advertisements.

Content identification systems for various data types, such as audio or video, use many different methods. A client device may capture a media sample recording of a media stream (such as radio), and may then request a server to perform a search of media recordings (also known as media tracks) for a match to identify the media stream. For example, the sample recording may be passed to a content identification server module, which can perform content identification of the sample and return a result of the identification to the client device. A recognition result may then be displayed to a user on the client device or used for various follow-on services, such as purchasing or referencing related information. Other applications for content identification include broadcast monitoring, for example.

Existing procedures for ingesting target content into a database index for automatic content identification include acquiring a catalog of content from a content provider or indexing a database from a content owner. Furthermore, existing sources of information to return to a user in a content identification query are obtained from a catalog of content prepared in advance.

### SUMMARY

In one example, a method is described comprising receiving, by one or more computing devices, a stream of incoming content recognition queries, and a given content recognition query includes a sample of media content and a request to identify the sample of media content. The method also comprises filtering, by the one or more computing devices, a plurality of content recognition queries from the stream of incoming content recognition queries belonging to a surge event, and the surge event is associated with content recognition queries received within a time window and including common samples of media content.

In another example, a non-transitory computer readable medium having stored thereon instructions, that when executed by one or more computing devices, cause the one or more computing devices to perform functions. The functions comprise receiving, by the one or more computing devices, a stream of incoming content recognition queries, and a given content recognition query includes a sample of media content and a request to identify the sample of media content. The functions also comprise filtering, by the one or more computing devices, a plurality of content recognition queries from the stream of incoming content recognition queries belonging to a surge event, and the surge event is associated with content recognition queries received within a time window and including common samples of media content.

In still another example, a system is described that comprises a surge filter including a limited selection of content, and a surge recognition engine coupled to the surge filter. The surge recognition filter receives a stream of incoming content recognition queries, and a given content recognition query includes a sample of media content and a request to identify the sample of media content. The surge recognition engine filters a plurality of content recognition queries from the stream of incoming content recognition queries belonging to a surge event by comparison to the limited selection of content in the surge filter, and the surge event is associated with content recognition queries received within a time window and including common samples of media content.

Any of the methods described herein may be provided in a form of instructions stored on a non-transitory, computer readable medium, that when executed by a computing device, cause the computing device to perform functions of the method. Further examples may also include articles of manufacture including tangible computer-readable media that have computer-readable instructions encoded thereon, and the instructions may comprise instructions to perform functions of the methods described herein. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage medium, or a computer readable memory, for example.

In still another example, systems may be provided that comprise at least one processor, and data storage configured to store the instructions that when executed by the at least one processor cause the system to perform functions.

In addition, circuitry may be provided that is wired to perform logical functions of any processes or methods described herein.

In still further examples, any type of devices or systems may be used or configured to perform logical functions of any processes or methods described herein. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions.

In yet further examples, any type of devices may be used or configured to include components with means for performing functions of any of the methods described herein (or any portions of the methods described herein).

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 illustrates one example of a system for identifying content within a data stream and for determining information associated with the identified content.

FIG. 2 illustrates an example diagram for performing a content recognition.

FIG. 3 is a block diagram of an example catalog of reference signatures.

FIG. 4 is a block diagram illustrating an example content identification and recognition system with surge detection.

FIG. 5 illustrates another example content identification and recognition system 500.

FIG. 6 is an example graph showing queries received over time.

FIG. 7 is an example graph illustrating signals present in ambient environment over time.

FIG. 8 shows a flowchart of an example method for detecting a surge and triggering a surge indicator.

FIG. 9 shows a flowchart of another example method for detecting a surge and identifying content.

FIG. 10 shows a flowchart of another example method for detecting a surge.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Within examples, media content identification from samples of media sources within various environments may be implemented using a content recognition service or content identification systems. A content recognition (pattern matching) service receives input from various client devices, e.g., mobile devices (smart phones), or non-mobile platforms. The content recognition service receives a query comprising a sample of content (some representation of the media sample, e.g., raw content or feature-extracted signatures or fingerprints) and searches a database index for matching known content. If the content is recognized then a result is returned to the client device that may display information about the sampled content, e.g., title, album art, purchasing options, etc.

There may be a baseline query rate of thousands of queries per second of independent unrelated content and source events. Under some circumstances, there may be a spike (or equivalently a “surge”) of upwards of tens of thousands or millions of queries per second. A content recognition service may be subjected to sudden surges in demand due to broadcasts with large audiences of users, and such users simultaneously submitted content recognition queries or requests to the system. A surge can increase load on the system by a large factor, requiring high compute capacity.

Such surges in activity may be sustained over a period of time. It is likely that such a sudden surge of queries results from the same correlated source event or content, such as a widely broadcast TV or radio show. Such content may be comprised of static or dynamic content. It is possible for there to be multiple simultaneous independent surges from a relatively small number of unrelated events.

In some examples, since surging request traffic may be significantly homogeneous or directed to the same or similar content, the system can be taught to adapt to a specific broadcast represented by the request traffic. This may be accomplished regardless of whether the broadcast content is already known to the system. In addition, the broadcast content often carries or includes additive non-catalog interfering content (e.g. dominant dialogue or sound effects), hereafter referred to as “embedded interference,” that can cause computationally expensive match failures. In some examples herein, embedded interference can be recognized as part of the signal of a traffic surge, thus enabling successful match results even from requests with no recognizable catalog content.

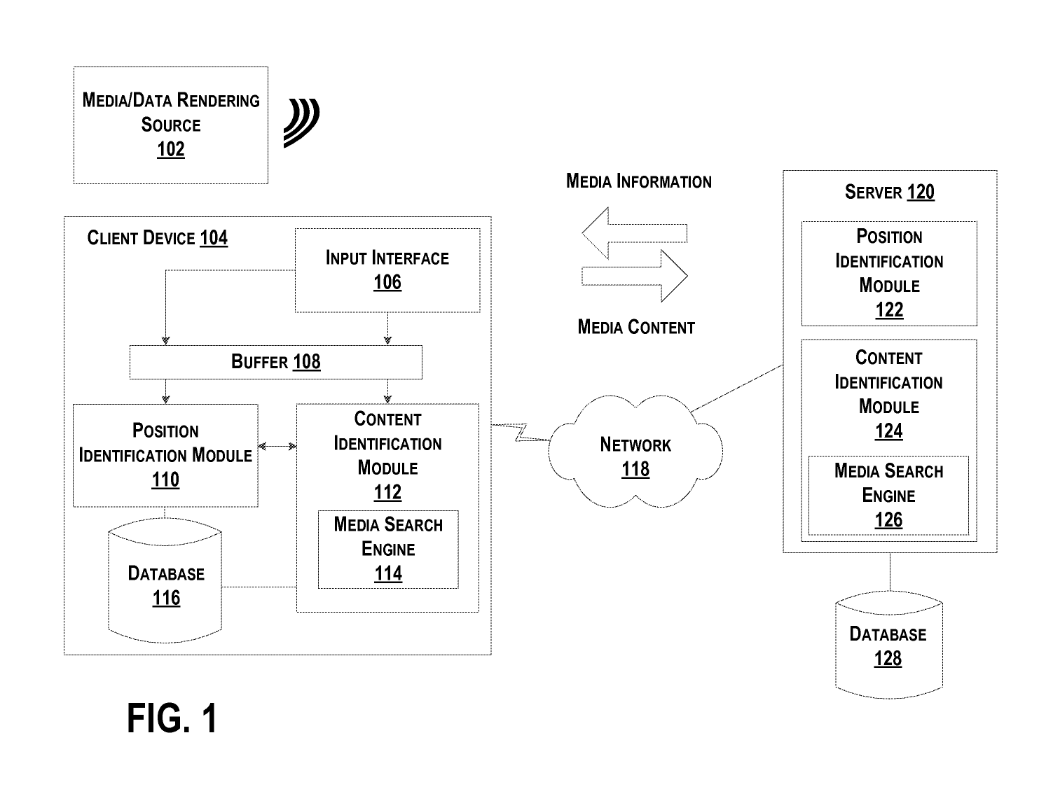

Referring now to the figures, FIG. 1 illustrates one example of a system for identifying content within a data stream and for determining information associated with the identified content. While FIG. 1 illustrates a system that has a given configuration, the components within the system may be arranged in other manners. The system includes a media or data rendering source 102 that renders and presents content from a media stream in any known manner. The media stream may be stored on the media rendering source 102 or received from external sources, such as an analog or digital broadcast. In one example, the media rendering source 102 may be a radio station or a television content provider that broadcasts media streams (e.g., audio and/or video) and/or other information. Thus, media content may include a number of songs, television programs, or any type of audio and/or video recordings, or any combination of such. The media rendering source 102 may also be any type of device that plays or audio or video media in a recorded or live format. In an alternate example, the media rendering source 102 may include a live performance as a source of audio and/or a source of video, for example. The media rendering source 102 may render or present the media stream through a graphical display, audio speakers, a MIDI musical instrument, an animatronic puppet, etc., or any other kind of presentation provided by the media rendering source 102, for example.

A client device 104 receives a rendering of the media stream from the media rendering source 102 through an input interface 106. In one example, the input interface 106 may include antenna, in which case the media rendering source 102 may broadcast the media stream wirelessly to the client device 104. However, depending on a form of the media stream, the media rendering source 102 may render the media using wireless or wired communication techniques. In other examples, the input interface 106 can include any of a microphone, video camera, vibration sensor, radio receiver, network interface, etc. The input interface 106 may be preprogrammed to capture media samples continuously without user intervention, such as to record all audio received and store recordings in a buffer 108. The buffer 108 may store a number of recordings or samples, or may store recordings for a limited time, such that the client device 104 may record and store recordings in predetermined intervals, for example, or in a way so that a history of a certain length backwards in time is available for analysis. In other examples, capturing of the media sample may be caused or triggered by a user activating a button or other application to trigger the sample capture.

The client device 104 can be implemented as a portion of a small-form factor portable (or mobile) electronic device such as a cell phone, a wireless cell phone, a personal data assistant (PDA), tablet computer, a personal media player device, a wireless web-watch device, a personal headset device, an application specific device, or a hybrid device that include any of the above functions. The client device 104 can also be implemented as a personal computer including both laptop computer and non-laptop computer configurations. The client device 104 can also be a component of a larger device or system as well.

The client device 104 further includes a position identification module 110 and a content identification module 112. The position identification module 110 is configured to receive a media sample from the buffer 108 and to identify a corresponding estimated time position (T_{S}) indicating a time offset of the media sample into the rendered media stream (or into a segment of the rendered media stream) based on the media sample that is being captured at that moment. The time position (T_{S}) may also, in some examples, be an elapsed amount of time from a beginning of the media stream. For example, the media stream may be a radio broadcast, and the time position (T_{S}) may correspond to an elapsed amount of time of a song being rendered.

The content identification module 112 is configured to receive the media sample from the buffer 108 and to perform a content identification on the received media sample. The content identification identifies a media stream, or identifies information about or related to the media sample. The content identification module 112 may be configured to receive samples of environmental audio, identify a content of the audio sample, and provide information about the content, including the track name, artist, album, artwork, biography, discography, concert tickets, etc. In this regard, the content identification module 112 includes a media search engine 114 and may include or be coupled to a database 116 that indexes reference media streams, for example, to compare the received media sample with the stored information so as to identify tracks within the received media sample. The database 116 may store content patterns that include information to identify pieces of content. The content patterns may include media recordings such as music, advertisements, jingles, movies, documentaries, television and radio programs. Each recording may be identified by a unique identifier (e.g., sound_ID). Alternatively, the database 116 may not necessarily store audio or video files for each recording, since the sound_IDs can be used to retrieve audio files from elsewhere. The database 116 may yet additionally or alternatively store representations for multiple media content recordings as a single data file where all media content recordings are concatenated end to end to conceptually form a single media content recording, for example. The database 116 may include other information (in addition to or rather than media recordings), such as reference signature files including a temporally mapped collection of features describing content of a media recording that has a temporal dimension corresponding to a timeline of the media recording, and each feature may be a description of the content in a vicinity of each mapped timepoint. For more examples, the reader is referred to U.S. Pat. No. 6,990,453, by Wang and Smith, which is hereby entirely incorporated by reference.

The database 116 may also include information associated with stored content patterns, such as metadata that indicates information about the content pattern like an artist name, a length of song, lyrics of the song, time indices for lines or words of the lyrics, album artwork, or any other identifying or related information to the file. Metadata may also comprise data and hyperlinks to other related content and services, including recommendations, ads, offers to preview, bookmark, and buy musical recordings, videos, concert tickets, and bonus content; as well as to facilitate browsing, exploring, discovering related content on the world wide web.

The system in FIG. 1 further includes a network 118 to which the client device 104 may be coupled via a wireless or wired link. A server 120 is provided coupled to the network 118, and the server 120 includes a position identification module 122 and a content identification module 124. Although FIG. 1 illustrates the server 120 to include both the position identification module 122 and the content identification module 124, either of the position identification module 122 and/or the content identification module 124 may be separate entities apart from the server 120, for example. In addition, the position identification module 122 and/or the content identification module 124 may be on a remote server connected to the server 120 over the network 118, for example.

The server 120 may be configured to index media content rendered by the media rendering source 102. For example, the content identification module 124 includes a media search engine 126 and may include or be coupled to a database 128 that indexes reference or known media streams, for example, to compare the rendered media content with the stored information so as to identify content within the rendered media content. The database 128 (similar to database 116 in the client device 104) may additionally or alternatively store multiple media content recordings as a single data file where all the media content recordings are concatenated end to end to conceptually form a single media content recording. A content recognition can then be performed by compared rendered media content with the data file to identify matching content using a single search. Once content within the media stream have been identified, identities or other information may be indexed in the database 128.

In some examples, as described above, the client device 104 may capture a media sample and may determine an identity of content in the media sample itself via the position identification module 110 and/or the content identification module 112. In other examples, the client device 104 may capture a media sample and may send the media sample over the network 118 to the server 120 to determine an identity of content in the media sample. In response to a content identification query received from the client device 104, the server 120 may identify a media recoding from which the media sample was obtained based on comparison to indexed recordings in the database 128. The server 120 may then return information identifying the media recording, and other associated information to the client device 104.

Generally, the client device 104 and/or the server 120 may perform a content recognition or identification of the sample of media content by computing characteristics or fingerprints of the media sample and comparing the fingerprints to previously identified fingerprints of reference media files.

Any number of content identification methods may be used depending on a type of content being identified. As an example, for images and video content identification, an example video identification algorithm is described in Oostveen, J., et al., “Feature Extraction and a Database Strategy for Video Fingerprinting”, Lecture Notes in Computer Science, 2314, (Mar. 11, 2002), 117-128, the entire contents of which are herein incorporated by reference. For example, a position of the video sample into a video can be derived by determining which video frame was identified. To identify the video frame, frames of the media sample can be divided into a grid of rows and columns, and for each block of the grid, a mean of the luminance values of pixels is computed. A spatial filter can be applied to the computed mean luminance values to derive fingerprint bits for each block of the grid. The fingerprint bits can be used to uniquely identify the frame, and can be compared or matched to fingerprint bits of a database that includes known media. Based on which frame the media sample included, a position into the video (e.g., time offset) can be determined.

As another example, for media or audio content identification (e.g., music), various content identification methods are known for performing computational content identifications of media samples and features of media samples using a database of known media. The following U.S. Patents and publications describe possible examples for media recognition techniques, and each is entirely incorporated herein by reference, as if fully set forth in this description: Kenyon et al, U.S. Pat. No. 4,843,562; Kenyon, U.S. Pat. No. 4,450,531; Haitsma et al, U.S. Patent Application Publication No. 2008/0263360; Wang and Culbert, U.S. Pat. No. 7,627,477; Wang, Avery, U.S. Patent Application Publication No. 2007/0143777; Wang and Smith, U.S. Pat. No. 6,990,453; Blum, et al, U.S. Pat. No. 5,918,223; Master, et al, U.S. Patent Application Publication No. 2010/0145708.

As one example, fingerprints of a received sample of media content can be matched to fingerprints of known media content by generating correspondences between equivalent fingerprints to locate a media recording that has a largest number of linearly related correspondences, or whose relative locations of characteristic fingerprints most closely match the relative locations of the same fingerprints of the recording. In some examples, a sound identifier of the matching media content recording can then be identified to determine a identity of the sample of content.

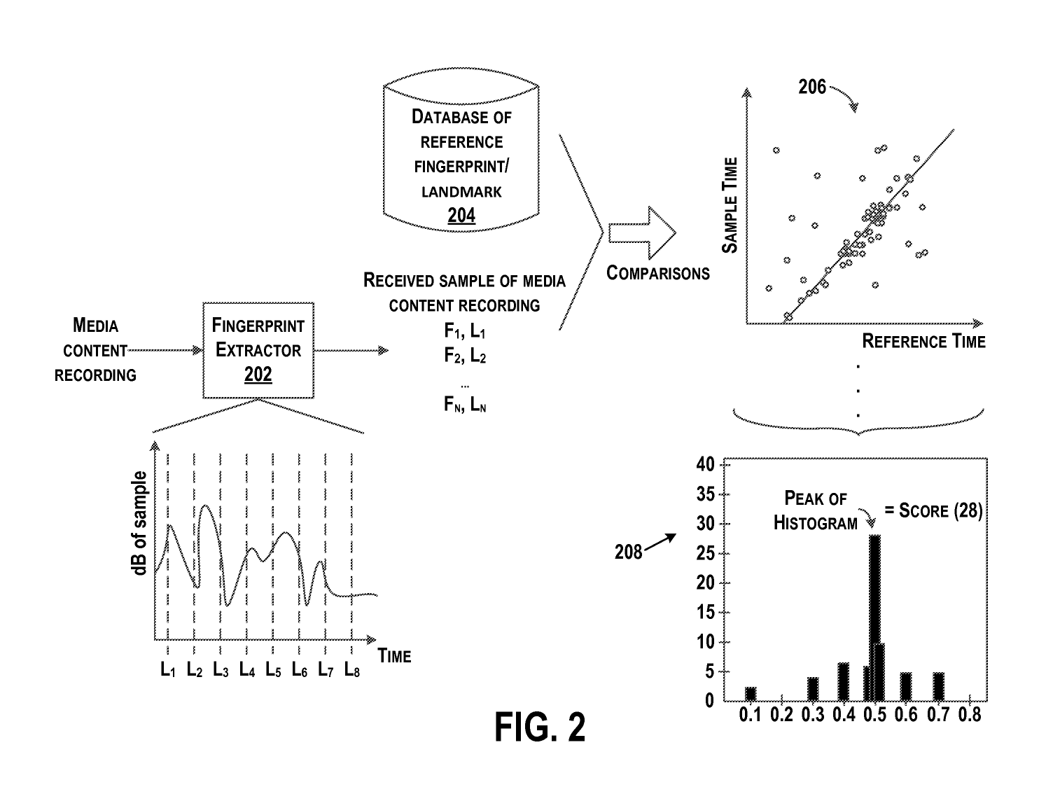

FIG. 2 illustrates an example diagram for performing a content recognition. Functions shown and described with respect to FIG. 2 may be implemented by a client device, by a server, or in combination between the client device and server, for example, and thus, components shown in FIG. 2 may be included within the client device and/or within the server.

Generally, media content can be identified by computing characteristics or fingerprints of a media sample and comparing the fingerprints to previously identified fingerprints of reference media files. Thus, initially, a media content recording or media sample may be received by a fingerprint extractor 202 that is configured to determine fingerprints of the media content recording. An example plot of dB (magnitude) of a sample vs. time is shown, and the plot illustrates a number of identified landmark positions (L₁ to L₈) in the sample.

Particular locations within the sample at which fingerprints are computed may depend on reproducible points in the sample. Such reproducibly computable locations are referred to as “landmarks.” One landmarking technique, known as Power Norm, is to calculate an instantaneous power at many time points in the recording and to select local maxima. One way of doing this is to calculate an envelope by rectifying and filtering a waveform directly. Once the landmarks have been determined, a fingerprint is computed at or near each landmark time point in the recording. The fingerprint is generally a value or set of values that summarizes a set of features in the recording at or near the landmark time point. In one example, each fingerprint is a single numerical value that is a hashed function of multiple features. Other examples of fingerprints include spectral slice fingerprints, multi-slice fingerprints, LPC coefficients, cepstral coefficients, and frequency components of spectrogram peaks.

The fingerprint extractor 202 may generate a set of fingerprints each with a corresponding landmark and provide the fingerprint/landmark pairs for each media content recording for comparison to reference fingerprint/landmark pairs stored in a database 204. For example, fingerprint and landmark pairs (F₁/L₁, F₂/L₂, . . . , Fₙ/Lₙ) can be determined and the fingerprints can be used to find matching fingerprints within the database 204 of known media content recordings. The fingerprints may be represented in the database 204 as key-value pairs where the key is the fingerprint and the value is a corresponding landmark. A value may also have an associated sound_ID within the database 204, for example, that maps to the identity of the referenced fingerprints/landmarks. Media recordings can be indexed with sound_ID from 0 to N−1, where N is a number of media recordings.

Fingerprints of a recording can be matched to fingerprints of known audio tracks by generating correspondences between equivalent fingerprints and files in the database 204 to locate a file that has a largest number of linearly related correspondences, or whose relative locations of characteristic fingerprints most closely match the relative locations of the same fingerprints of the recording. Referring to FIG. 2, a scatter plot 206 of landmarks of the sample and a reference file at which fingerprints match (or substantially match) is illustrated. After generating a scatter plot, linear correspondences between the landmark pairs can be identified, and sets can be scored according to the number of pairs that are linearly related. A linear correspondence may occur when a statistically significant number of corresponding sample locations and reference file locations can be described with substantially the same linear equation, within an allowed tolerance, for example. The reference file of the set with the highest statistically significant score, i.e., with the largest number of linearly related correspondences, is the winning file, and may be deemed the matching media file. In one example, to generate a score for a file, a histogram 208 of offset values can be generated. The offset values may be differences in landmark time positions between the sample and the reference file where a fingerprint matches. FIG. 2 illustrates an example histogram 208 of offset values. The reference file may be given a score that is equal to the peak of the histogram (e.g., score=28 in FIG. 2). Each reference file can be processed in this manner to generate a score, and the reference file that has a highest score may be determined to be a match to the sample.

In other examples, as additions or alternative to using a histogram, the Hough transform or RANSAC algorithms may be used to determine or detect a linear or temporal correspondence between time differences.

Still other examples of content identification and recognition include speech recognition (transcription of spoken language of target media content into text) and person identification (speaker identification when a voice is present or facial recognition).

Thus, within examples, content identification and recognition makes use of content signatures, extracted from identified media content, and a recognition algorithm to compare the signatures for similarity. The system maintains a catalog of reference signatures extracted from identified, clean source tracks, and uses the recognition algorithm to match incoming query signatures that have been extracted from samples of content recorded from ambient audio sources. The recognition algorithm is capable of matching query signatures that contain artifacts due to various factors such as embedded interference and distortion.

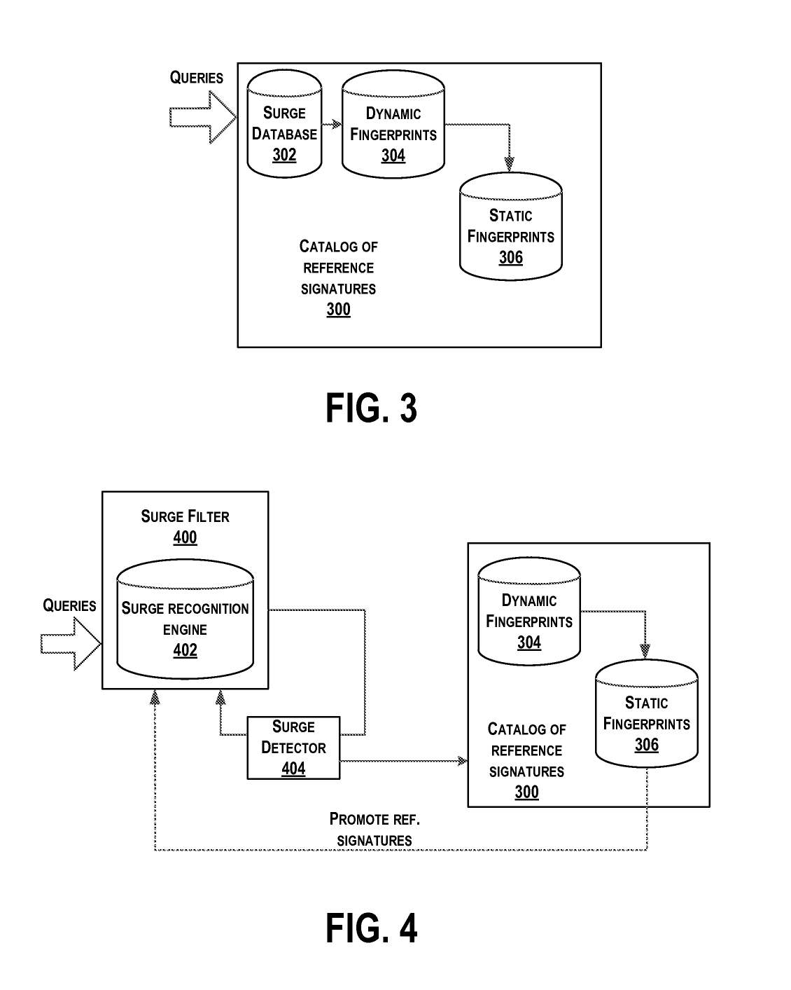

Content identification and recognition may operate according to a number of search algorithms. FIG. 3 is a block diagram of an example catalog of reference signatures 300. The catalog of reference signatures 300 may include more or fewer databases, and some of the databases may be combined or divided up into additional databases, and still further, the databases may be ordered in any manner. Each database may contain reference signals of audio, video, or media content within a category of the database. As shown, the catalog of reference signatures 300 includes a surge database 302, a database of dynamic fingerprints 304 (real-time live streams of content, e.g., radio, TV, live performances), and a database of static fingerprints 306 (unchanging content, e.g., music recordings, movies, advertisements).

The content identification and recognition system may utilize a number of search algorithms when identifying content to adjust for varying amounts of embedded interference or distortion in queries.

Surges in demand or increases in received queries can occur frequently. In many cases, a normal request rate can be doubled or tripled during peak traffic periods. Surges are generally caused by a broadcast of some sort, whether via radio or television or even a large public performance. The surge queries, therefore, typically represent the same underlying content. Hence, the surge queries may have a quality of homogeneity that is normally absent from the flow of queries generally received. When many users send queries to identify the same content at generally the same time, then the surge occurs, which includes a statistically significant rate of requests (above a threshold) for the content. As an example, a given threshold may include more than 100 requests for the content within a second. Other thresholds may be higher or lower depending on the size of an audience for given broadcasts. When a surge of queries occurs, requests for content that include known or popular content and are relatively free of embedded interference may be identified at the increased query rate. That is, the increase of queries can be handled by a small, fast cache that utilizes low computational resources, for example.

Thus, in cases of surges directed to static or dynamic content that is not indexed in the catalog of reference signatures 300, the unidentifiable queries search through the catalog of reference signatures 300 and end up with no-match, and consume a considerable amount of computational capacity.

Within some examples, since a surge of content queries usually originates from a single or small number of source events, e.g., a popular TV program or new hit song being broadcast, the queries of such “instantaneously popular” content comprising a spike may be approximately temporally coincident and directed to the same content. When the system is arranged such that a front-most, smallest and fastest cache contains underlying content of the surge, the system may efficiently identify and respond to all queries.

FIG. 4 is a block diagram illustrating an example content identification and recognition system with surge detection. In FIG. 4, queries may be received at a surge filter 400, which is configured to detect surges of queries for content that may be obscure and unknown content, or known content. The surge filter 400 is shown to include a surge recognition engine 402, which includes catalog or reference signatures of content identified as possibly highly relevant to multiple content recognition requests. The surge filter 400 will determine matches of samples of the incoming queries to any of the catalogued reference signatures via the surge recognition engine 402, and when a match is found, a result can be returned to the querying device.

The surge filter 400 may perform as a content identification and recognition engine to perform matching of the samples to the catalogued reference queries via the surge recognition engine 402. A surge is typically due to an event with a large audience trying to identify the same content at the same time. This correlated pattern enables the surge recognition engine 402 to be populated with selected content, so that the surge filter 400 may separate incoming queries belonging to a common surge event from a stream of incoming queries related to any number of other events, thus acting as a “surge protector” to a main recognition engine. Examples described here enable filtering of queries due to both queries for known catalog content and unknown content. Known catalog content may be static or dynamic. Multiple simultaneous surge events may be present in the query stream and the surge recognition engine 402 may be loaded with surge content corresponding to each surge event.

Surge content may include known catalog content or unknown ghost content. Catalog content comes from a database associated with the main recognition engine and holding possibly many millions of items. This content may be static or dynamic. Ghost content is unknown material that may be absent from the content catalog but whose existence is inferred from homogeneity in the incoming stream of queries during a contemporaneous window of history (i.e. “ghost analysis window”).

A surge detector 404 is coupled to the surge filter 400 and can monitor outputs of the surge filter 400 to detect surges and determine content for inclusion into the surge recognition engine 402. As one example, the surge detector 404 may count the number of IDs of matches of the results from the content identification and recognition engine. The surge detector 404 can trigger a surge indicator or identify a surge once a number of the IDs has surpassed a threshold within a given time period.

Thus, the surge filter 400, may in one example, detect a rising number of requests for a particular piece of content based on outputs of the content identification process. Each piece of content that is recognized within a recent interval of time may be associated with a counter in the surge detector 404 that counts a number of recent identifications of the content. Once the count exceeds a threshold, such as one hundred requests for the content within one second, a surge may be flagged. In an example implementation, an associative map entry is accessed with a matching content ID and that map entry containing a counter data structure. One implementation has a simple counter that is incremented for each recognition event. The counter may be periodically reset to zero. Another example includes keeping track of age of each event and removing entries that are past a certain age. The count of remaining recent events for the given ID is then tallied. Still another example includes exponentially decaying or otherwise diminishing a value of the counter as a function of time, thus not needing to keep track of the age of any particular entry. An associative map may be periodically pruned of entries that have not had a recognition event in the recent past. Yet another implementation may operate on blocks of recognized content IDs in a recent predetermined period of time, e.g. the latest 500 milliseconds. The content IDs can be recorded into a buffer, and at an end of the predetermined period of time the list is sorted and the count for each content ID is tallied. In the above example implementations, if a number of queries for a given content ID is above a given threshold, a spike is flagged for that piece of content.

In another example, a surge may be detected by the surge filter 400 comparing queries against themselves, and when a threshold number of matches are determined (e.g., detecting homogeneity), this may be indicative to detecting a surge. Thus, the surge filter 400 may detect surges by directly comparing incoming queries to recent queries, determine which recent queries are part of the surge, and use recent queries that are part of the surge as a basis for recognizing underlying content of the surge in subsequent incoming queries. In this way, a surge may be detected without determining an identity of the underlying content.

The surge recognition engine 402 can be populated and loaded with the underlying content of the surge, e.g., such as the catalogued reference signatures. In the example shown in FIG. 4, a surge is identified as being directed to content broadcast by a radio station, and reference signatures of the broadcasted content are promoted to the first surge database 302. Then, for subsequently received queries which may likely include the same popular content, the surge filter 400 may have faster access to the reference signatures that are promoted to the surge database 302 for content recognition.

The surge recognition engine 402 can also be populated and loaded with content from the incoming queries themselves, for example.

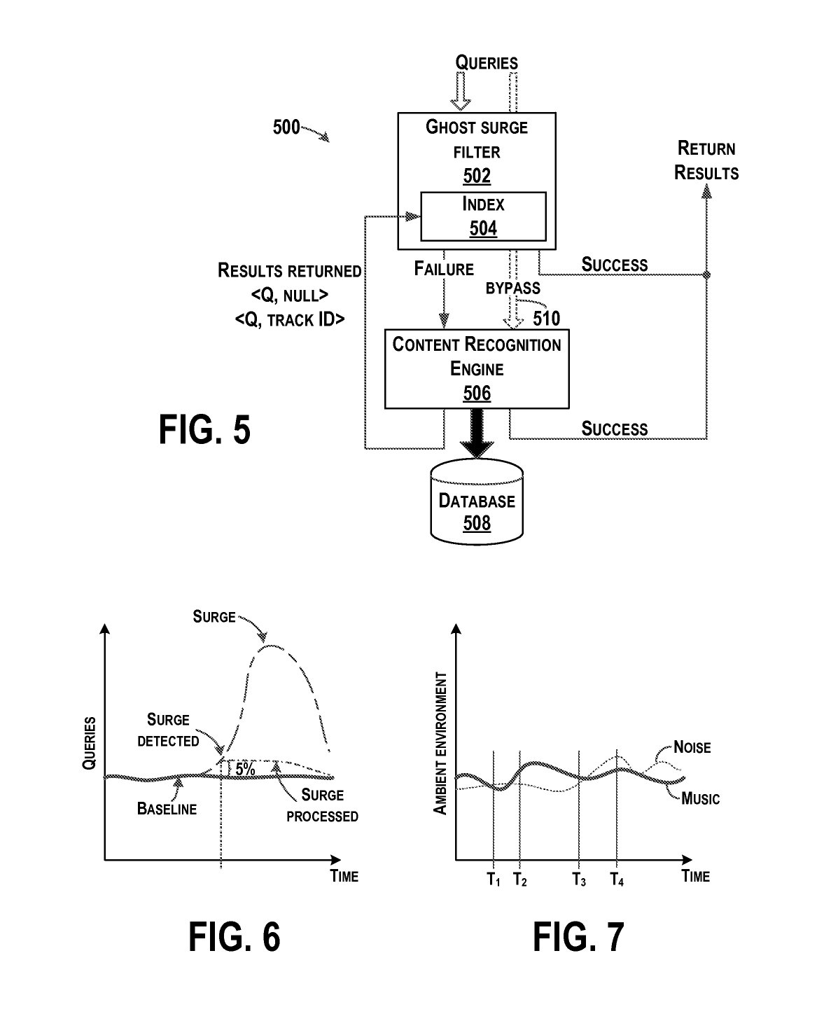

FIG. 5 illustrates another example content identification and recognition system 500. The system 500 includes a ghost surge filter 502 that receives incoming queries, and the ghost surge filter 502 includes an index 504 or filter storing content for use in an initial filter process. For example, each incoming query is first input into the ghost surge filter 502 for matching against content in the index 504. The query may match with content loaded in the surge index 504, at which case, a recognition result can be returned and further searching can be avoided. In instances in which the query may not match to any content in the surge index 504, the query can be passed to a content recognition engine 506 for further processing. Alternatively, a statistically representative sample set of the incoming query stream may be passed to the content recognition engine 506 via bypass 510, instead of only the no-matches from the ghost surge filter 502. The content recognition engine 506 performs content identification by reference to a database 508 including a catalog of referenced known media content. The ghost surge filter 502 and the content recognition engine 506 may be components of a server, or may be separate servers themselves.

The surge index 504 includes a limited selection of content, and is loaded with content deemed to mirror that queried during a surge. Within examples, the surge content may be known content or unknown content, and may be a reference exemplar of content or a copy of an incoming query itself

Known content (e.g., catalog content) may be referenced explicitly and may include a reference exemplar of the surge content, which may be dynamic or static catalog content derived from a media recording or live stream. As an example, an incoming query may be received by the ghost surge filter 502 that attempts to match the query to content in the index 504. When no match is found, the query is passed to the content recognition engine 506 that attempts to match the query to content in the database 508 including a catalog of content. The content recognition engine 506 provides to the ghost surge filter 502 a recognition result of the content recognition queries. The recognition result may include a query signature, and when a match is found, a list of matching catalog reference signatures. As shown in FIG. 5, recognition results may be in the form of <Q, Null> for no matches, and <Q, track ID> when there is a match. In this example, the ghost surge filter 502 may load the surge index 504 with the matching catalog reference signatures, which are considered known content.

Known content may be referenced implicitly and may include a sample set of contemporaneous query content. In such examples, the contemporaneous queries themselves serve as the content against which incoming queries are matched. This implicitly loaded content covers all possible cases of surges and no decision procedure is necessary to decide what is loaded into the surge filter index 504 other than to take a portion of the incoming query samples into the surge filter index 504.

As an example, a sample set of contemporaneous query content may be chosen as content that obtains a statistically representative sample of the incoming query stream, e.g., randomly. The selection of contemporaneous query content may select queries within a “ghost analysis window” near the time of a given incoming query. The ghost surge filter 502 may be updated periodically, e.g., once per second.

As mentioned, the surge index 504 may also be loaded with content comprising the incoming queries themselves. For example, if at least some of the sample set of queries loaded into the surge filter index 504 have been identified and labeled as identified catalog content, such as by passing at least some of the indexed sample set of queries through the content recognition engine 506 and matching those against the catalog content database 508, then such queries have been identified and can be loaded into the index 504. Thus, when an incoming query is passed through the surge filter index 504, the incoming query may match a number of the indexed sample set of queries, and if a threshold number of the matches have a consensus identity, then the incoming query may be labeled with the same identity. Otherwise, the incoming query may be labeled as being part of a surge of other unknown content.

Unknown content is content known to be currently unidentifiable due to absence of matching content in a catalog, for example, such as when a new song has been released but not yet included in the catalog of songs. In such instances, the content recognition engine 506 may return a null result along with the query signature generated from content of the query that can be loaded into the surge index 504. Thus, when a query has content that matches to the query signature of the null result in the search index 504, that query cannot be identified due to matching to known “unknown content”, and it would be fruitless to continue searching in a broader catalog of content for a match by the content recognition engine 506. Thus, a result can be returned by the ghost surge filter 502 indicating that a match cannot be found and further searching can be avoided.

In other examples, it may be possible to selectively load unknown content as the queries that remain when other stages of processing have produced “no matches”, thereby loading query content that corresponds to unknown content. In such examples, the surge filter index 504 is tuned to categorize incoming queries into correlated “known unknown” content (e.g., content that has been previously processed and determined that it is unidentifiable by the system).

By comparing incoming queries to prior received and identified queries, it is possible to identify content in queries that includes embedded interference. Consensus recognition of the catalog content may be possible if high-embedded-interference regions of the media stream are bridged by overlapping queries identifiable as catalog content.

Still further, the index 504 may be loaded with unknown content that can be represented by an explicit exemplar which may be constructed in a number of ways. As an example, from the incoming queries, a consensus representation of a ghost content stream (e.g., content not identified) may be stitched together into a single timeline in order to create a virtual channel of streaming content. This may be accomplished by counting fingerprints with matching values out of time-aligned sets of fingerprints from a sample set of contemporaneous queries and constructing a master timeline with the consensus fingerprints, each of which exceeds a certain threshold count across the sample set of individual queries. The resulting consensus fingerprint timeline thus includes fingerprints that agree in temporal placement as well as fingerprint value (e.g., hash). It represents an inferred content stream having the same fingerprints as if the original content stream were being ingested directly, and thus may be treated as another form of catalog content. Such stitched-together consensus streams of unknown content maybe archived for later identification by other means, e.g. by human operators.

In further detail, the incoming queries may have accurate (e.g., NTP) timestamps that allow placement of fingerprints on an aggregate timeline. But if inaccurate timestamps or no timestamps at all are available, then relative placement of fingerprints on an inferred timeline can be constructed. If no timestamp is explicitly available, then an approximate timestamp may be taken as an arrival time of a query at the recognition server. Inferring the consensus fingerprint timeline may be accomplished by constrained optimization (e.g., least squares) on the temporal offset for each query such that for each individual consensus fingerprint its corresponding copies across the sample set of queries agree on a consensus time placement.

The ghost surge filter 502 may include a fixed-length buffer, i.e. “ghost analysis window,” storing the recognition results given by the content recognition engine 506 for the prior received queries. A recognition result for a query may include a query signature and a list of matching catalog entry identifiers or track identifier. A track ID list may be empty (when no match found) or may contain a single or multiple entries. Results with an empty track id list are null recognition results, and those with one or more entries are positive recognition results.

During a surge, each result in the index 504 in the ghost surge filter 502 will either be part of the surge or not. In some examples, a homogeneity threshold, q, may be defined as a required proportion of the index 504 having an identical source or content to constitute a surge. Detecting a surge based on a known track can be accomplished by counting occurrences of each unique track ID listed in the results, and noting any counts exceeding q. In this state, and given a sufficiently large value of q, a next incoming query has an increased probability of belonging to the surge, i.e., of representing a track whose ID count exceeds q.

Thus, within examples, an incoming query can be classified as a match to a currently surging track if the incoming query matches one or more other queries that are also of the surging track.

The stored entries in the index 504 may be removed if a match rate of incoming content recognition queries to a given prior received content recognition query falls being below a given threshold in a given time interval, indicating that a surge for such content has ended.

The ghost surge filter 502 may identify a surge based on a number of the given recognition results in the ghost analysis window having same matching catalog reference signatures being above a threshold, and identify content associated with the same matching catalog reference signatures as being associated with the surge. The incoming content recognition queries may be received from a plurality of devices and recognition results may be returned to the devices as output from the ghost surge filter 502 (when successful) or output from the content recognition engine 506.

Corresponding catalog content from the content recognition engine 506 that has been detected as explaining a surge (having a hit rate above a threshold) may then be promoted into the surge filter index 504 by copying the reference content to the surge filter index 504. If hits go below a certain rate, then that reference content may be removed from the surge filter index 504.

In some examples, surges may also be implicitly detected, i.e. no surge detection mechanism is present and no detection event is used to trigger loading of exemplar content into the surge filter. Instead, as previously discussed, a statistically representative sample set of contemporaneous queries can be loaded into the surge filter index 504 regardless of surge detection. Then, as described above, to operate the filter, if an incoming query matches a threshold number of contemporaneous queries (i.e. “homogeneity threshold” in a “ghost analysis window”) then the incoming query may be classified as belonging to a surge of queries with the same provenance.

Within examples, loading the surge filter index 504 with surge content, as well as determining whether an incoming query belongs to a surge does not necessarily require determining an explicit reference exemplar of the surge content to load into the surge filter index 504 nor detect a surge for triggering the loading of a corresponding reference exemplar. Thus, deciding whether to abort further recognition effort on a given incoming query may be based on checking homogeneity against a contemporaneous amount of received queries, for example.

FIG. 6 is an example graph showing queries received over time. The system may operate at a baseline level of queries being received on average. During a surge, an increase of queries may be received. However, using the system 500 of surge detection, the surge may be detected relatively quickly, such that within receipt of about 5% of surge queries, all incoming queries for the surge are processed through the surge filter and the queries only increase a small amount above baseline.

Example methods herein further improve chances for successful matching of queries. For example, matches of broadcasts with embedded interference can be made that may be difficult or have a low probability if matching were performed on the query using only the content recognition engine 506 and the catalog database 508. Such matching can be performed due to consistency of the embedded interference within the broadcast.

Embedded interference may include any distortion to signal, such as for example, a TV show with dialog mixed in with signal. During a surge, many users may tag the TV show, for example, and some matches may occur against catalog content, but other queries may not include enough catalog content for a match due to excess embedded interference. In such instances, a mixture of matches against catalog content is determined even though all queries are part of the surge.

FIG. 7 is an example graph illustrating signals present in ambient environment over time. At various sample times of T₁, T₂, T₃, and T₄, portions of a music signal and portions of embedded interference may be captured. Depending on a relative amount of the music signal to embedded interference in the sample, a match to catalog content may be determined. When a majority of the sample includes embedded interference, a match may be indeterminate or return a null result.

Thus, within examples, queries of a broadcast typically contain both known catalog content and embedded interference. When the queries are used as reference signatures during surge detection, an embedded interference portion of the content may be matched to an incoming query along with the catalog content. This means that incoming queries that have less catalog content than necessary to match to the catalog, but still have consistent embedded interference, can be matched to the reference surge signatures.

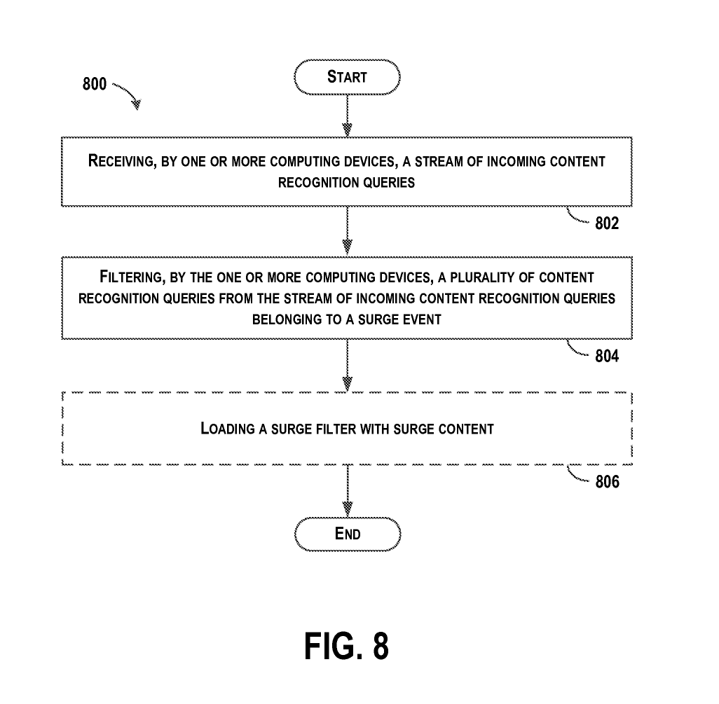

FIG. 8 shows a flowchart of an example method 800 for detecting a surge and triggering a surge indicator. Method 800 shown in FIG. 8 presents an embodiment of a method that, for example, could be used with the system shown in FIGS. 1, 4 and 5, for example, and may be performed by a computing device (or components of a computing device) such as a client device or a server or may be performed by components of both a client device and a server. Method 800 may include one or more operations, functions, or actions as illustrated by one or more of blocks 802-806. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

It should be understood that for this and other processes and methods disclosed herein, flowcharts show functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium or data storage, for example, such as a storage device including a disk or hard drive. The computer readable medium may include non-transitory computer readable medium or memory, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a tangible computer readable storage medium, for example.

In addition, each block in FIG. 8 may represent circuitry that is wired to perform the specific logical functions in the process. Alternative implementations are included within the scope of the example embodiments of the present disclosure in which functions may be executed out of order from that shown or discussed, including substantially concurrent or in reverse order, depending on the functionality involved, as would be understood by those reasonably skilled in the art.

At block 802, the method 800 includes receiving, by one or more computing devices, a stream of incoming content recognition queries. A given content recognition query includes a sample of media content and a request to identify the sample of media content. As one example, a client device may receive the sample of media content from an ambient environment of the computing device, such as via a microphone, receiver, etc., and may record and store the sample. A server may then receive, from a number of client devices, a number of incoming content recognition queries including various samples of media content.

At block 804, the method 800 includes filtering, by the one or more computing devices, a plurality of content recognition queries from the stream of incoming content recognition queries belonging to a surge event. In examples, the surge event is associated with content recognition queries received within a time window and including common samples of media content. The time window may be variable, and can be on the order of seconds, for example, or longer based on a broadcast from which the surge originates.

Within one example, filtering includes providing the stream of incoming content recognition queries to a surge filter for matching with a limited selection of content, and for given content recognition queries in the stream of incoming content recognition queries not matching with the limited selection of content, providing the given content recognition queries to a recognition engine for content identification via matching with catalog content. As described above, anything not matching to the surge filter index can be passed to the main recognition engine for further processing.

Within another example, filtering includes matching the sample of media content matching with known catalog content in the surge filter, and providing a recognition content identification result of the known catalog content and concluding further searching. Filtering may still alternatively include matching the sample of media content with unknown content in the surge filter, and providing an indication that an identity of the sample of media content is unknown and concluding further searching. Unknown content includes content previously searched by a recognition engine via comparison to content of a catalog and recognized as content with an unknown identity absent from the catalog.

At block 806, the method 800 optional includes loading a surge filter with surge content. The surge content may be determined in a number of ways.

As one example, surge content may include a reference exemplar of surge content from a catalog of content, and incoming content recognition queries may be matched the reference exemplars.

As another example, surge content may include content included within the received stream of incoming content recognition queries themselves, and content within the stream of incoming content recognition queries themselves serves as content against which incoming queries are matched. During the matching, the sample of media content may be identified to have the consensus identity of that as determined for prior queries based on the sample of media content matching a threshold number of the set of content that have the consensus identity. The surge filter may be loaded with content included within the stream of incoming content recognition queries received within the time window of a given incoming query.

The surge filter can also be loaded with content included within the stream of incoming content recognition queries deemed to be queries for unknown content that has been recognized as content with an unknown identity absent from a catalog of content referenced by a recognition engine for content identification. In this example, based on the sample of media content matching with the unknown content in the surge filter, an indication can be provided that an identity of the sample of media content is unknown and further searching can be concluded (rather than continuing to search using the main content recognition engine).

Thus, within examples, the method 800 may optionally include generating a composition of content used for filtering the stream of incoming content recognition queries from the stream of incoming content recognition queries themselves.

In further examples, content may be loaded into the surge filter based on promotion from other databases. For instance, the stream of incoming content recognition queries can be provided to the surge filter for matching with a limited selection of content, and for given content recognition queries in the stream of incoming content recognition queries not matching with the limited selection of content in the surge filter, the given content recognition queries can be provided to the recognition engine for content identification via matching with catalog content. Content recognitions of the given content recognition queries can be performed by a matching process of the sample of media content, per the given content recognition queries, to media content stored in one or more databases that are arranged as a sequential set of databases and the surge filter is a first database of the sequential set, and a matching stored media content to the remaining content recognition queries can be promoted forward in the matching process to the surge filter.

The method 800 may optionally include detecting surge events. As an example, content recognitions of the stream of incoming content recognition queries can be performed and a count of a number of content recognitions resulting in a same media content identification can be maintained. Based on the count exceeding a threshold, the surge event can be detected. The threshold amount may be, for example, one hundred identifications of the same content within a one second period. Furthermore, multiple surge events can be detected, based on multiple groups of content recognition queries including samples of the same media content and on given numbers of content recognition queries in the given groups being above the threshold over a given amount of time.

Using the method 800, surges of instantaneously popular content can be promoted to a first database of a hierarchical catalog, and with an amount of content in the first database being low, a search may take on the order of a microsecond of searching. The first database may be arranged to be at the top level of the recognition hierarchy in order to intercept and absorb all surge queries. Recognition queries not matched at the first database are then passed to a remainder of the recognition hierarchy.

A recognition rate of recent matches within the first database can be maintained for each piece of content stored therein, and if a recent recognition rate in a given time interval falls below a given threshold (e.g., less than 50 matches within 1 minute) then the content can flagged as no longer being a part of the surge and removed.

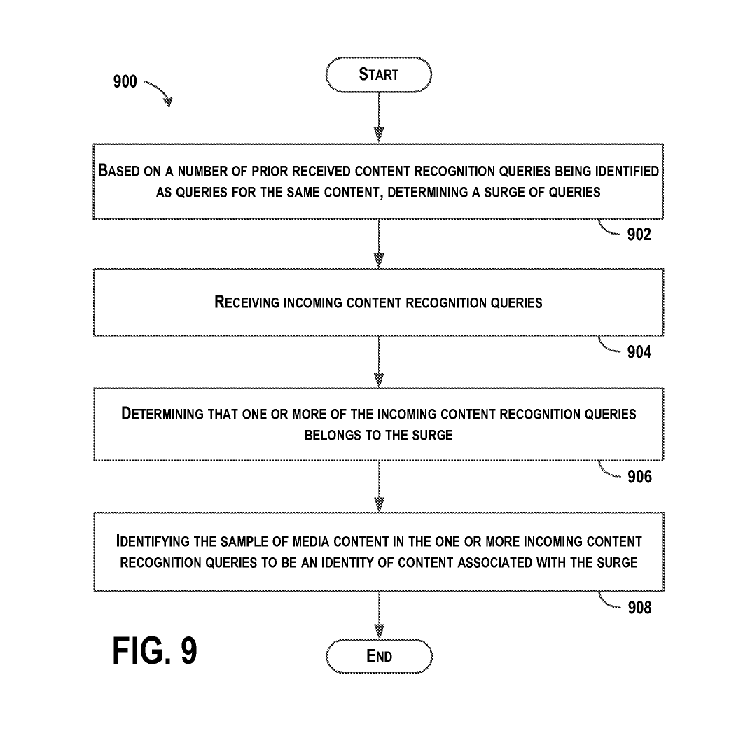

FIG. 9 shows a flowchart of another example method 900 for detecting a surge and identifying content. Method 900 shown in FIG. 9 presents an embodiment of a method that, for example, could be used with the system shown in FIGS. 1 and 4-5, for example, and may be performed by a computing device (or components of a computing device) such as a client device or a server or may be performed by components of both a client device and a server. Method 900 may include one or more operations, functions, or actions as illustrated by one or more of blocks 902-908. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

Blocks shown in FIG. 9 may represent a module, a segment, or a portion of program code, which includes one or more instructions executable by a processor for implementing specific logical functions or steps in the process. The program code may be stored on any type of computer readable medium or data storage, for example, such as a storage device including a disk or hard drive. The computer readable medium may include non-transitory computer readable medium or memory, for example.

At block 902, the method 900 includes based on a number of prior received content recognition queries being identified as queries for the same content, determining a surge of queries. As described above, once a threshold number of content recognitions are performed and noted for the same content, a surge of queries for that content may be determined.

At block 904, the method 900 includes receiving incoming content recognition queries, and a given incoming content recognition query includes a sample of media content. At block 906, the method 900 includes determining, by a computing device, that one or more of the incoming content recognition queries belongs to the surge. Within some examples, matches between the incoming content recognition queries and the prior received content recognition queries can be determined based on directly comparing the queries, or fingerprints of the queries, to each other. Based on determining a match, the incoming content recognition queries can be associated with the surge. This is true, since any incoming query that matches to a prior query (or fingerprints from the incoming query that match to fingerprints of the prior query) will be a query for the same content that has been identified for the surge.

At block 908, the method 900 includes identifying, by the computing device, the sample of media content in the one or more incoming content recognition queries to be an identity of content associated with the surge. Thus, when an incoming query is associated with the surge, an identity of content of the surge will be an identity of content for the incoming query and can be returned to the client device as a recognition result.

Within some examples, sometimes the incoming content recognition queries may include less catalog content than necessary to match to a catalog of identified media content. For example, an incoming query may include a substantial amount of embedded interference. Using the method 900, the incoming content recognition queries may be determined to match to at least one of the prior received content recognition queries, and the incoming content recognition queries can be recognized as being associated to the identity of content associated with the surge. In this way, once a surge is determined, and queries are associated with the surge, content identifications can be inferred due to the surge association. This enables a content identification result to be returned to a client device when otherwise unable to do so due to a sample including embedded interference that would result in no matches to the indexed reference catalog.

As an example, referring back to FIG. 5, the ghost surge filter 502 receives many queries, some of which are part of a surge. A count of track identifiers from the results returned from the content recognition engine 506 is maintained, and when a certain track identifier count exceeds a threshold (e.g., say 128 counts), then a surge is deemed for that track identifier (e.g., a surge of content identification requests are being received that include samples of media corresponding to that track identifier). New incoming queries are matched to the prior queries associated with the surge, and when a match is found to a prior query that has that track identifier attached, then the new incoming query is considered to be part of the surge and the same track identifier is associated to the new incoming query. In this way, the incoming query does not need to have any catalog signal in the sample, but rather just needs to match to a prior received query that may have a combination of catalog signal and embedded interference. Matching to the embedded interference may bridge the identification of the new incoming query to the catalog signal.

In further examples, the prior received content recognition queries may be associated with recognition results for unknown identity of content when no matches were previously found. Following, a signature (e.g., fingerprint) of the incoming content recognition queries can be compared with the prior received content recognition queries, and when a match is found, the incoming content recognition queries represent media content absent from a catalog of identified media content. Thus, the system can determine, based on initial comparisons of incoming queries to prior queries that had no matches that the incoming queries also will result in no match, and such incoming queries can be filtered out prior to processing the incoming queries through the entire hierarchy of databases.

Thus, when the surge is associated with an unknown identity of content, and the incoming content recognition queries match to at least one of the prior received content recognition queries, the incoming content recognition queries are also recognized as being associated to the unknown identity of content associated with the surge. By surge protecting against spikes in recognition requests, the system may recognize queries that will not match and move those queries out of the system.

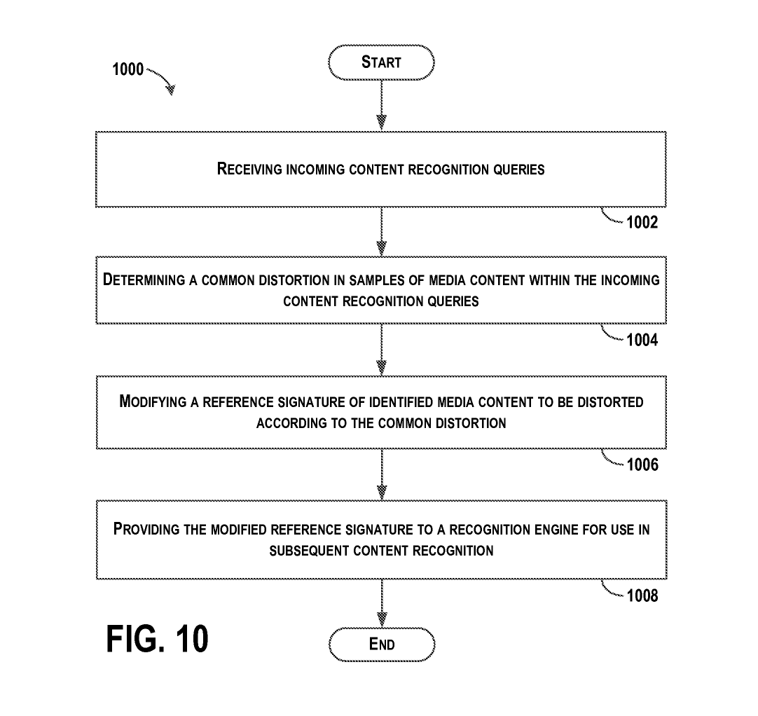

FIG. 10 shows a flowchart of another example method 1000 for detecting a surge. Method 1000 shown in FIG. 10 presents an embodiment of a method that, for example, could be used with the system shown in FIGS. 1 and 4-5, for example, and may be performed by a computing device (or components of a computing device) such as a client device or a server or may be performed by components of both a client device and a server. Method 1000 may include one or more operations, functions, or actions as illustrated by one or more of blocks 1002-1008. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

Blocks shown in FIG. 10 may represent a module, a segment, or a portion of program code, which includes one or more instructions executable by a processor for implementing specific logical functions or steps in the process. The program code may be stored on any type of computer readable medium or data storage, for example, such as a storage device including a disk or hard drive. The computer readable medium may include non-transitory computer readable medium or memory, for example.

At block 1002, the method 1000 includes receiving incoming content recognition queries, and a given incoming content recognition query includes a sample of media content of a media source and a request to identify the sample of media content. At block 1004, the method 1000 includes determining, by a computing device, a common distortion in samples of media content within the incoming content recognition queries.

Determining the common distortion may include determining a time stretch associated with a playback speed of the sample of media content by the media source to a reference speed of identified media content in a catalog. In some instances, the media stream may be rendered by a media rendering source at an unexpected speed. For example, if a musical recording is being played on an uncalibrated turntable or CD player, the music recording could be played faster or slower than an expected reference speed, or in a manner differently from the stored reference media stream. Or, sometimes a DJ may change a speed of a musical recording intentionally to achieve a certain effect, such as matching a tempo across a number of tracks. As examples of reference speeds, a CD player is expected to be rendered at 44100 samples per second; a 45 RPM vinyl record is expected to play at 45 revolutions per minute on a turntable; and an NTSC video stream is expected to play at 60 frames per second. Within some examples, methods described in U.S. Pat. No. 7,627,477, entitled “Robust and invariant audio pattern matching”, the entire contents of which are herein incorporated by reference, can be performed to identify the media sample, an estimated identified media stream position T_{S}, and a speed ratio R.

For instance, within examples, a content recognition may be performed, by a client device or server, based on a captured media sample. A timestamp (T₀) may be recorded from a reference clock of the client device when a sample is recorded. An estimated identified media stream position (T_{S}) indicating a time offset of the media sample into a media stream based on the media sample that is captured can also be determined based on a comparison of fingerprints of the sample to catalog fingerprints, and determined of offsets in time of the matching catalog fingerprints from a beginning of the reference catalog file. (T_{S} may also, in some examples, be an elapsed amount of time from a beginning of the media stream plus elapsed time since the time of the timestamp).

To estimate the speed ratio R, cross-frequency ratios of variant parts of matching fingerprints are calculated, and because frequency is inversely proportional to time, a cross-time ratio is the reciprocal of the cross-frequency ratio. A cross-speed ratio R is the cross-frequency ratio (e.g., the reciprocal of the cross-time ratio).

More specifically, using the methods described above, a relationship between two audio samples can be characterized by generating a time-frequency spectrogram of the samples (e.g., computing a Fourier Transform to generate frequency bins in each frame), and identifying local energy peaks of the spectrogram. Information related to the local energy peaks is extracted and summarized into a list of fingerprint objects, each of which optionally includes a location field, a variant component, and an invariant component. Certain fingerprint objects derived from the spectrogram of the respective audio samples can then be matched. A relative value is determined for each pair of matched fingerprint objects, which may be, for example, a quotient or difference of logarithm of parametric values of the respective audio samples.

In one example, local pairs of spectral peaks are chosen from the spectrogram of the media sample, and each local pair comprises a fingerprint. Similarly, local pairs of spectral peaks are chosen from the spectrogram of a known media stream, and each local pair comprises a fingerprint. Matching fingerprints between the sample and the known media stream are determined, and time differences between the spectral peaks for each of the sample and the media stream are calculated. For instance, a time difference between two peaks of the sample is determined and compared to a time difference between two peaks of the known media stream. A ratio of these two time differences can be determined and a histogram can be generated comprising such ratios (e.g., extracted from matching pairs of fingerprints). A peak of the histogram may be determined to be an actual speed ratio (e.g., ratio between the speed at which the media rendering source is playing the media compared to the reference speed at which a reference media file is rendered). Thus, an estimate of the speed ratio R can be obtained by finding a peak in the histogram, for example, such that the peak in the histogram characterizes the relationship between the two audio samples as a relative pitch, or, in case of linear stretch, a relative playback speed.

Alternatively, a relative value may be determined from frequency values of matching fingerprints from the sample and the known media stream. For instance, a frequency value of an anchor point of a pair of spectrogram peaks of the sample is determined and compared to a frequency value of an anchor point of a pair of spectrogram peaks of the media stream. A ratio of these two frequency values can be determined and a histogram can be generated comprising such ratios (e.g. extracted from matching pairs of fingerprints). A peak of the histogram may be determined to be an actual speed ratio R. In an equation form

$${R}_{f} = \frac{{f}_{sample}}{{f}_{stream}} \qquad Equation ( 1 )$$

where fₛₐₘₚₗₑ and f^{stream} are variant frequency values of matching fingerprints, as described by Wang and Culbert, U.S. Pat. No. 7,627,477, the entirety of which is hereby incorporated by reference.

Thus, a global relative value (e.g., speed ratio R) can be estimated from matched fingerprint objects using corresponding variant components from the two audio samples. The variant component may be a frequency value determined from a local feature near the location of each fingerprint object. The speed ratio R could be a ratio of frequencies or delta times, or some other function that results in an estimate of a global parameter used to describe the mapping between the two audio samples. The speed ratio R may be considered an estimate of the relative playback speed, for example.

In still other examples, determining the common distortion may include determining a pitch shift associated with a pitch of the sample of media content by the media source to a reference pitch of the identified media content in the catalog. The pitch shift may be determined, similarly to the time stretch, by comparing differences in frequency of the sample and catalog fingerprints.

At block 1006, the method 1000 includes modifying a reference signature of the identified media content to be distorted according to the common distortion. For example, after a content recognition identifies the media content and returns a reference signature, the reference signature can be modified to adjust the pitch of frequency fingerprints to be pitch shifted as seen in the distortion, or fingerprints can be time stretched or shifted as seen in the distortion.

At block 1008, the method 1000 includes providing, by the computing device, the modified reference signature to a recognition engine for use in subsequent content recognition. Thus, once the modified reference signature is used for comparison to new incoming queries of a surge, since it is likely that all surge queries are due to the same source, the new incoming queries will have the same time or pitch stretch parameters and no further distortion needs to be accounted for during content recognitions. Pre-warping the reference signature used for comparison (i.e., query signatures of prior received and recognized queries) and promoting those signatures to the initial or micro-index enables new queries that have the same distortion to be identified quickly. In addition, once distortion is recognized, a time/pitch skew matching algorithm, as described above, is not needed enabling faster recognition times.

Within examples, using the method 1000, when a spike of queries against a given piece of content is from the same broadcast source, then the speed and pitch ratios should nominally be the same for all queries from the spike since all samples of that source should be stretched in the same way. An invariant matching algorithm, such as algorithms disclosed in U.S. Pat. No. 7,627,477 (the entirety of which is hereby incorporated by reference) may have lower sensitivity than a non-invariant algorithm, such as algorithms disclosed in U.S. Pat. No. 6,990,453 (the entirety of which is hereby incorporated by reference). Thus, it may be beneficial to pre-warp a fingerprint representation of the matching content when query signatures of the content are inserted into the micro database. In such a case, the more sensitive non-invariant algorithm may be used. One way to pre-warp content inserted into the micro database is to apply the time and/or frequency stretch ratios to the raw media file (e.g., resampling and/or pitch-bending) and then performing fingerprint extraction. Another way is to perform a coordinate transformation on the fingerprint representation directly. As an example, the algorithm in U.S. Pat. No. 6,990,453, the fingerprints include pairs of spectrogram peaks. The pre-warping may then be accomplished by multiplying the time coordinate of each spectrogram peak by a time stretch ratio and/or multiplying the frequency coordinate by a frequency stretch ratio. The pre-warped content is then indexed into the micro database, or first database of the hierarchical database structure.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

What is claimed is:

1. A method comprising:
receiving, by one or more computing devices, a stream of incoming content recognition queries, wherein a given content recognition query includes a sample of media content and a request to identify the sample of media content; and
filtering, by the one or more computing devices, a plurality of content recognition queries from the stream of incoming content recognition queries belonging to a surge event, wherein the surge event is associated with content recognition queries received within a time window and including common samples of media content.

2. The method of claim 1, wherein filtering the plurality of content recognition queries from the stream of incoming content recognition queries belonging to the surge event comprises:
providing the stream of incoming content recognition queries to a surge filter for matching with a limited selection of content; and
for given content recognition queries in the stream of incoming content recognition queries not matching with the limited selection of content, providing the given content recognition queries to a recognition engine for content identification via matching with catalog content.

3. The method of claim 1, wherein filtering the plurality of content recognition queries from the stream of incoming content recognition queries belonging to the surge event comprises:
for the stream of incoming content recognition queries, determining whether the sample of media content matches content within a surge filter; and
based on the sample of media content matching with known catalog content in the surge filter, providing a recognition content identification result of the known catalog content and concluding further searching, wherein the known catalog content includes content previously indexed and identified.

4. The method of claim 1, wherein filtering the plurality of content recognition queries from the stream of incoming content recognition queries belonging to the surge event comprises:
for the stream of incoming content recognition queries, determining whether the sample of media content matches content within a surge filter; and
based on the sample of media content matching with unknown content in the surge filter, providing an indication that an identity of the sample of media content is unknown and concluding further searching, wherein the unknown content includes content previously searched by a recognition engine via comparison to content of a catalog and recognized as content with an unknown identity absent from the catalog.

5. The method of claim 1, wherein filtering the plurality of content recognition queries from the stream of incoming content recognition queries belonging to the surge event comprises:
for the stream of incoming content recognition queries, determining whether the sample of media content matches content within a surge filter; and
based on lack of a match of the sample of media content with content in the surge filter, passing the given content recognition query to a recognition engine for content identification via matching with catalog content.

6. The method of claim 1, further comprising:
loading a surge filter with a reference exemplar of surge content from a catalog of content; and
for the stream of incoming content recognition queries, determining whether the sample of media content matches content within the surge filter.

7. The method of claim 6, further comprising:
determining, by the one or more computing devices, a common distortion in samples of media content within given content recognition queries;
modifying the reference exemplar of surge content to be distorted according to the common distortion; and
providing, by the one or more computing devices, the modified reference exemplar of surge content for use in subsequent content recognition.

8. The method of claim 1, further comprising:
loading a surge filter with a set of content included within the received stream of incoming content recognition queries; and
for the stream of incoming content recognition queries, determining whether the sample of media content matches content within the surge filter so that content within the stream of incoming content recognition queries themselves serve as content against which incoming queries are matched.

9. The method of claim 8, further comprising based on the sample of media content matching a threshold number of the set of content that have a consensus identity, identifying the sample of media content to have the consensus identity.

10. The method of claim 8, wherein loading the surge filter with the set of content included within the received stream of incoming content recognition queries comprises:
loading the surge filter with content included within the stream of incoming content recognition queries received within the time window of a given incoming query.

11. The method of claim 8, wherein loading the surge filter with the set of content included within the stream of incoming content recognition queries comprises:
loading the surge filter with content included within the stream of incoming content recognition queries deemed to be queries for unknown content that has been recognized as content with an unknown identity absent from a catalog of content referenced by a recognition engine for content identification.

12. The method of claim 11, further comprising:
based on the sample of media content matching with the unknown content in the surge filter, providing an indication that an identity of the sample of media content is unknown and concluding further searching, wherein the unknown content includes content previously searched by a recognition engine via comparison to content of a catalog and recognized as content with an unknown identity absent from the catalog.

13. The method of claim 1, further comprising:
performing content recognitions of the stream of incoming content recognition queries;
maintaining a count of a number of content recognitions resulting in a same media content identification; and
based on the count exceeding the threshold, detecting the surge event.

14. The method of claim 13, further comprising
detecting multiple surge events, based on multiple groups of content recognition queries including samples of the same media content and on given numbers of content recognition queries in the given groups being above the threshold over a given amount of time.

15. The method of claim 13, further comprising:
loading a surge filter with a reference exemplar of surge content for content representative of the same media content identification; and
wherein filtering the plurality of content recognition queries comprises comparing respective samples of media content in the plurality of content recognition queries to content within the surge filter.

16. The method of claim 1, wherein filtering the plurality of content recognition queries from the stream of incoming content recognition queries belonging to the surge event comprises:
providing the stream of incoming content recognition queries to a surge filter for matching with a limited selection of content;
for given content recognition queries in the stream of incoming content recognition queries not matching with the limited selection of content, providing the given content recognition queries to a recognition engine for content identification via matching with catalog content; and
promoting a matching stored media content to the surge filter.

17. The method of claim 1, wherein filtering the plurality of content recognition queries from the stream of incoming content recognition queries belonging to the surge event comprises:
comparing a given query that includes embedded interference to prior received queries identified as belonging to the surge event and associated with a given track identity;
based on a match of the given query to prior received queries identified as belonging to the surge event, determining that the given query also belongs to the surge event; and
associating the given track identity to the given query thereby recognizing a given unrecognizable query including excess embedded interference by association to prior received and recognized queries.

18. The method of claim 1, further comprising:
from the incoming content recognition queries, combining unidentified content together to create a virtual channel of streaming content;
loading a surge filter with selected exemplars of surge content from the virtual channel of streaming content; and
for the stream of incoming content recognition queries, determining whether the sample of media content matches content within the surge filter.

19. The method of claim 18, wherein combining the unidentified content together to create the virtual channel of streaming content comprises:
determining fingerprints from a sample set of contemporaneous queries having matching values; and
generating a timeline of the matching fingerprints as the virtual channel of streaming content, wherein the timeline includes fingerprints that agree in temporal placement as well as value.

20. A non-transitory computer readable medium having stored thereon instructions, that when executed by one or more computing devices, cause the one or more computing devices to perform functions comprising:
receiving, by the one or more computing devices, a stream of incoming content recognition queries, wherein a given content recognition query includes a sample of media content and a request to identify the sample of media content; and
filtering, by the one or more computing devices, a plurality of content recognition queries from the stream of incoming content recognition queries belonging to a surge event, wherein the surge event is associated with content recognition queries received within a time window and including common samples of media content.

21. The non-transitory computer readable medium of claim 20, wherein filtering the plurality of content recognition queries from the stream of incoming content recognition queries belonging to the surge event comprises:
providing the stream of incoming content recognition queries to a surge filter for matching with a limited selection of content; and
for given content recognition queries in the stream of incoming content recognition queries not matching with the limited selection of content, providing the given content recognition queries to a recognition engine for content identification via matching with catalog content.

22. The non-transitory computer readable medium of claim 20, wherein the functions further comprise:
for the stream of incoming content recognition queries, determining whether the sample of media content matches content within a surge filter;
based on the sample of media content matching with known catalog content in the surge filter, providing a recognition content identification result and concluding further searching, wherein the known catalog content includes content previously indexed and identified;
based on the sample of media content matching with unknown content in the surge filter, providing an indication that an identity of the sample of media content is unknown and concluding further searching, wherein the unknown content includes content previously searched by a recognition engine via comparison to content of a catalog and recognized as content with an unknown identity absent from the catalog; and
based on lack of a match of the sample of media content with content in the surge filter, passing the given content recognition query to a recognition engine for content identification via matching with catalog content.

23. The non-transitory computer readable medium of claim 20, wherein the functions further comprise:
loading a surge filter with a reference exemplar of surge content from a catalog of content; and
for the stream of incoming content recognition queries, determining whether the sample of media content matches content within the surge filter.

24. The non-transitory computer readable medium of claim 20, wherein the functions further comprise:
loading a surge filter with a set of content included within the received stream of incoming content recognition queries; and
for the stream of incoming content recognition queries, determining whether the sample of media content matches content within the surge filter so that content within the stream of incoming content recognition queries themselves serve as content against which incoming queries are matched.

25. The non-transitory computer readable medium of claim 20, further comprising:
generating a composition of content used for filtering the stream of incoming content recognition queries from the stream of incoming content recognition queries.

26. A system comprising:
a surge filter including a limited selection of content; and
a surge recognition engine coupled to the surge filter and receiving a stream of incoming content recognition queries, wherein a given content recognition query includes a sample of media content and a request to identify the sample of media content, the surge recognition engine filtering a plurality of content recognition queries from the stream of incoming content recognition queries belonging to a surge event by comparison to the limited selection of content in the surge filter, wherein the surge event is associated with content recognition queries received within a time window and including common samples of media content.

27. The system of claim 26, wherein the surge recognition engine provides remaining content recognition queries in the stream of incoming content recognition queries to a recognition engine for content identification via matching with catalog content.

28. The system of claim 26, wherein the surge filter is loaded with a reference exemplar of surge content from a catalog of content.

29. The system of claim 26, wherein the surge filter is loaded with a set of content included within the received stream of incoming content recognition queries, and the surge recognition engine determines whether the sample of media content matches content within the surge filter so that content within the stream of incoming content recognition queries themselves serve as content against which incoming queries are matched.

30. The system of claim 26, wherein the surge recognition engine is configured to generate a composition of content as the limited selection of content within the surge filter from the stream of incoming content recognition queries.

31. The system of claim 26, wherein the surge recognition engine is configured to:
for the stream of incoming content recognition queries, determine whether the sample of media content matches content within a surge filter;
based on the sample of media content matching with known catalog content in the surge filter, provide a recognition content identification result and conclude further searching, wherein the known catalog content includes content previously indexed and identified;
based on the sample of media content matching with unknown content in the surge filter, provide an indication that an identity of the sample of media content is unknown and conclude further searching, wherein the unknown content includes content previously searched by a recognition engine via comparison to content of a catalog and recognized as content with an unknown identity absent from the catalog; and
based on lack of a match of the sample of media content with content in the surge filter, pass the given content recognition query to a recognition engine for content identification via matching with catalog content.
